(19) United States
(12) Patent Application Publication
(10) Pub. No.: US 2024/0354860 A1
(43) Pub. Date: Oct. 24, 2024

(54) CLIENT LEAD NOTIFICATION

(71) Applicant: Consumer Agent Portal, LLC dba TrustedChoice.com, Brooklyn Center, MN (US)

(72) Inventor: Charles Joseph Bacciocco, IV, Brookfield, WI (US)

(21) Appl. No.: 18/631,229

(22) Filed: Apr. 10, 2024

Related U.S. Application Data
(60) Provisional application No. 63/496,850, filed on Apr. 18, 2023.

(51) Int. Cl. G06Q 40/08

(52) U.S. Cl. CPC G06Q 40/08

(57) ABSTRACT

A method includes receiving information identifying an insurance client lead; using the received information identifying the insurance client lead to identify, from a database of a plurality of insurance agents, a subset of one or more insurance agents from the plurality of insurance agents; transmitting a client lead notification to each of the subset of the one or more insurance agents from the plurality of insurance agents, with the client lead notification corresponding to the insurance client lead; receiving a lead claim response to the client lead notification from a first insurance agent of the subset of the one or more insurance agents, with the lead claim response indicating a claim of the insurance client lead by the first insurance agent; and, in response to receiving the lead claim response from the first insurance agent, connecting the first insurance agent with the insurance client lead.

### RELATED APPLICATION

This disclosure claims priority to U.S. provisional patent application No. 63/496,850 filed on Apr. 18, 2023, the contents of which are hereby incorporated by reference.

### TECHNICAL FIELD

The disclosure relates generally to devices, systems (e.g., networked systems), and methods for transmitting a client lead notification. More specifically, embodiments disclosed herein relate to devices, systems (e.g., networked systems), and methods for transmitting a client lead notification to one or more service providers and connecting a client lead with a service provider who has claimed that client lead in response to the client lead notification.

### BACKGROUND

In a variety of industries, the process of finding a client/customer and closing on a business transaction with that client/customer can be time-consuming and inefficient. For example, in the insurance industry, any given client could be in the market looking for any one or more of a variety of insurance policy types, and any given insurance agent could offer in the market any one or more of a variety of insurance policy types that may or may not match the insurance policy type(s) the client is looking to purchase in the market. As such, it can be time-consuming and inefficient for each of the potential client and the insurance agent to investigate whether there is a match to facilitate an insurance policy sale transaction. Then, after time and resources have been spent finding such a match, the process of closing on the insurance policy sale transaction can oftentimes be inefficient and have a relatively low yield in terms of successfully converting a matching potential client into a purchasing customer. For example, in addition to the time and resources expended in finding a matching potential client, additional time and resources are then spent attempting to convert that matching potential client into a purchasing client, including educating the potential client on the details of the policy type(s), answering questions the potential client may have relating to the details of the one or more policies, and otherwise working to try and close on the insurance policy sale transaction. Accordingly, in view of the effort and resources expended over what is usually an extended period of time, the typical relatively low yield in lead conversion success can result in significant inefficiencies in resource requirements and utilization.

### SUMMARY

In general, this disclosure relates to devices, systems (e.g., networked systems), and methods for transmitting a client lead notification to one or more service providers and connecting a client lead with a service provider who has claimed that client lead in response to the client lead notification. Embodiments are described herein in the context of service providers using the example of insurance agents (e.g., independent insurance agents) and potential clients using the example of insurance policy purchasing clients. Though in other examples embodiments within the scope of the present disclosure can include applications in other goods or services industries.

Techniques described herein can help to increase the efficiency associated with buying and selling a good or service. For example, embodiments disclosed herein as applied to the insurance industry can help to identify in real-time licensed professional insurance agents that: (i) are best suited to help a specific inquiring potential insurance buyer with that buyer's specific current insurance need(s) and (ii) are currently, right now available and willing to interact with that buyer to sell an insurance policy to that buyer fitting that buyer's specific need(s).

In particular, embodiments disclosed herein can receive information identifying an insurance client lead, such as including data relating to that insurance client lead's specific needs, such as a particular insurance policy type for a particular type of business or residence at a particular location, and utilize that received information identifying the insurance client lead to filter through various data points associated licensed insurance agents to identify a subset of such insurance agents that match the received information identifying the insurance client lead. Such embodiments can then notify insurance agents in the identified subset of the current existence of an insurance client lead that matches those insurances agents in the subset. Such embodiments can enable at least one of those matching insurance agents to then claim that insurance client lead, and these embodiments can connect the claiming insurance agent to that insurance client lead. Notably, such embodiments can make this connection via a warm insurance client lead, for instance making this connection between the claiming insurance agent and the insurance client lead all while the insurance client lead is maintained on a phone line throughout the process of receiving the information identifying the insurance client lead to the point of connecting the claiming insurance agent and the insurance client lead. For example, this connection can include transferring an in progress phone call with the insurance client lead to the insurance agent from whom a lead claim response was received while the insurance client lead was maintained on the phone call.

In this way, such embodiments disclosed herein can provide a number of useful advantages. As one example, embodiments disclosed herein can significantly increase the efficiency associated with a sales process. For instance, with respect to the example application in the insurance industry, the ability of embodiments as disclosed herein to provide a warm lead (e.g., transferring an active phone call with an insurance client lead to a lead claiming insurance agent) can help to increase the yield in lead conversion success while at the same time decrease the needed resource expenditure by the claiming insurance agent to close on that lead. As such, these embodiments can utilize data and analytics to identify an insurance client lead for a subset of insurance agents best suited to close on that lead and, in addition, provide a warm connection to that insurance client lead to help increase the odds of a successful sale transaction. Disclosed embodiments can provide this useful advantage through a combination of unique data acquired from insurance agents (e.g., acquiring from each of a plurality of insurance agents an indication as to whether the respective insurance agent of the plurality of insurance agents is currently available for a phone call) and unique mechanism to generate a warm lead and transfer that warm lead to a claiming insurance agent.

One embodiment includes a method. This method embodiment includes receiving information identifying an insurance client lead, and using the received information identifying the insurance client lead to identify, from a database of a plurality of insurance agents, a subset of one or more insurance agents from the plurality of insurance agents. This method embodiment further includes transmitting a client lead notification to each of the subset of the one or more insurance agents from the plurality of insurance agents, with the client lead notification corresponding to the insurance client lead. This method embodiment also includes receiving a lead claim response to the client lead notification from a first insurance agent of the subset of the one or more insurance agents, with the lead claim response indicating a claim of the insurance client lead by the first insurance agent. And this method embodiment includes, in response to receiving the lead claim response from the first insurance agent, connecting the first insurance agent with the insurance client lead.

In a further embodiment of the method, connecting the first insurance agent with the insurance client lead can include transferring a phone call with the insurance client lead to the first insurance agent. For instance, the lead claim response can be received from only the first insurance agent of the subset of the one or more insurance agents (e.g., the lead claim response can only be validly received from one insurance agent and, thus, the insurance client lead can only be connected with that one such insurance agent). In one such example, the information identifying the insurance client lead can be received via the phone call with the insurance client lead and prior to transferring the phone call with the insurance client lead to the first insurance agent. Both the client lead notification can be transmitted and the lead claim response can be received while the phone call with the insurance client lead is occurring and prior to transferring the phone call with the insurance client lead to the first insurance agent. In a further such embodiment, the method can additionally include: receiving, from each of the plurality of insurance agents in the database, an indication as to whether the respective insurance agent of the plurality of insurance agents is currently available for a phone call. As such, in this particular embodiment, identifying the subset of one or more insurance agents from the plurality of insurance agents can include using the received information identifying the insurance client lead and the indication as to whether the respective insurance agent of the plurality of insurance agents is currently available for the phone call.

In a further embodiment of the method, the received information identifying the insurance client lead can include a type of insurance policy desired by the insurance client lead and a location where the type of insurance policy desired by the insurance client lead is to be applied. For example, using the received information identifying the insurance client lead to identify the subset of one or more insurance agents from the plurality of insurance agents can include using the type of insurance policy desired by the insurance client lead and the location where the type of insurance policy desired by the insurance client lead is to be applied to identify the subset of one or more insurance agents from the plurality of insurance agents as those insurance agents offering the type of insurance policy desired by the insurance client lead at the location where the type of insurance policy desired by the insurance client lead is to be applied.

In a further embodiment of the method, the method can additionally include setting a lead claim price to charge as a result of receiving the lead claim response to the client lead notification from the first insurance agent; and transmitting the lead claim price, along with the client lead notification, to each of the subset of the one or more insurance agents from the plurality of insurance agents. For example, the lead claim price can be determined using each of a type of insurance policy desired by the insurance client lead, a location where the type of insurance policy desired by the insurance client lead is to be applied, a time of day when the client notification is transmitted, and a total number of insurance agents in the subset of one or more insurance agents identified from the database of the plurality of insurance agents. In such an example, the lead claim price can be set to a first lead claim price and the first lead claim price can be transmitted, along with the client lead notification, to each of the subset of the one or more insurance agents from the plurality of insurance agents. In this example, the method can further include: after transmitting the first lead claim price, decreasing the first lead claim price to a second, lesser lead claim price in response to a predetermined amount of time passing, after transmitting the client lead notification to each of the subset of the one or more insurance agents, without yet having received the lead claim response; and transmitting the second, lesser lead claim price, along with the client lead notification, to each of the subset of the one or more insurance agents from the plurality of insurance agents.

In a further embodiment of the method, the client lead notification can be transmitted to each of the subset of the one or more insurance agents from the plurality of insurance agents along with an indicator indicating whether the insurance client lead is currently waiting on a phone line to talk with an insurance agent of the subset of the one or more insurance agents. For example, the client lead notification can be transmitted to each of the subset of the one or more insurance agents from the plurality of insurance agents additionally along with a type of insurance policy desired by the insurance client lead and a calculated estimated agent premium fee associated with the type of insurance policy desired by the insurance client lead.

In a further embodiment of the method, the method can additionally include, in response to receiving the lead claim response from the first insurance agent, transmitting to the first insurance agent the received information identifying the insurance client lead.

In a further embodiment of the method, the method can additionally include, in response to receiving the lead claim response from the first insurance agent, transmitting a feedback prompt to the first insurance agent requesting from the first insurance agent information relating to a sale of an insurance policy to the insurance client lead. For example, the information relating to the sale of the insurance policy to the insurance client lead included in the feedback prompt transmitted to the first insurance agent can include a request for information from the first insurance agent as to any additional insurance policy sold to the insurance client lead beyond a type of insurance policy indicted as desired by the insurance client lead in the received information identifying the insurance client lead.

Another embodiment includes a computing device. This computing device embodiment includes programmable processing circuitry; a non-transitory storage medium coupled to the programmable processing circuitry; and a transceiver coupled to the programmable processing circuitry and configured to receive and transmit data via a network. The programmable processing circuitry is configured to cause the device to: receive information identifying an insurance client lead; use the received information identifying the insurance client lead to identify, from a database of a plurality of insurance agents, a subset of one or more insurance agents from the plurality of insurance agents; transmit a client lead notification to each of the subset of the one or more insurance agents from the plurality of insurance agents, the client lead notification corresponding to the insurance client lead; receive a lead claim response to the client lead notification from a first insurance agent of the subset of the one or more insurance agents, the lead claim response indicating a claim of the insurance client lead by the first insurance agent; and, in response to receiving the lead claim response from the first insurance agent, connect the first insurance agent with the insurance client lead.

In a further embodiment of this computing device, the programmable processing circuitry can be configured to cause the device to connect the first insurance agent with the insurance client lead by transferring a phone call with the insurance client lead to the first insurance agent. And, in a further such embodiment, the programmable processing circuitry can be configured to cause the device to both transmit the client lead notification and receive the lead claim response while the phone call with the insurance client lead is occurring and prior to transferring the phone call with the insurance client lead to the first insurance agent. In an additional such embodiment, the programmable processing circuitry can be further configured to: receive, from each of the plurality of insurance agents in the database, an indication as to whether the respective insurance agent of the plurality of insurance agents is currently available for a phone call; and identify the subset of one or more insurance agents from the plurality of insurance agents by using the received information identifying the insurance client lead and the indication as to whether the respective insurance agent of the plurality of insurance agents is currently available for the phone call.

In a further embodiment of this computing device, the programmable processing circuitry can be further configured to: set a first lead claim price to charge as a result of receiving the lead claim response to the client lead notification from the first insurance agent; transmit the first lead claim price, along with the client lead notification, to each of the subset of the one or more insurance agents from the plurality of insurance agents; after transmitting the first lead claim price, decrease the first lead claim price to a second, lesser lead claim price in response to a predetermined amount of time passing, after transmitting the client lead notification to each of the subset of the one or more insurance agents, without yet having received the lead claim response; and transmit the second, lesser lead claim price, along with the client lead notification, to each of the subset of the one or more insurance agents from the plurality of insurance agents.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

The following drawings are illustrative of particular examples of the present invention and therefore do not limit the scope of the invention. The drawings are not necessarily to scale, though embodiments can include the scale illustrated, and are intended for use in conjunction with the explanations in the following detailed description wherein like reference characters denote like elements. Examples of the present invention will hereinafter be described in conjunction with the appended drawings.

FIG. 1 is a schematic block diagram illustrating an embodiment of a system for transmitting a client lead notification, in accordance with some examples of this disclosure.

FIG. 2 is a flow diagram illustrating an embodiment of a method for transmitting a client lead notification, in accordance with some examples of this disclosure.

FIG. 3 is an embodiment of a user interface that includes one example of a client lead notification, in accordance with some examples of this disclosure.

FIG. 4 is an embodiment of a user interface that includes one example of information identifying a client lead transmitted to a service provider in response to that service provider having claimed the corresponding client lead, in accordance with some examples of this disclosure.

### DETAILED DESCRIPTION

The following detailed description is exemplary in nature and is not intended to limit the scope, applicability, or configuration of the invention in any way. Rather, the following description provides some practical illustrations for implementing examples of the present invention. Those skilled in the art will recognize that many of the noted examples have a variety of suitable alternatives.

Embodiments disclosed herein can utilize data and analytics to identify, in substantially real-time, a subset of one or more licensed professional insurance agent(s) that is: (i) best suited to help a specific inquiring insurance buyer with that inquiring buyer's specific, current insurance policy need(s), and (ii) currently available to engage with that inquiring insurance buyer (e.g., input received from that agent that he/she is right now able to join an ongoing phone call with that inquiring insurance buyer) right now and willing to provide the specified service to that insurance buyer (e.g., input received from that agent that he/she is right now able to sell a specific type of insurance policy the inquiring insurance buyer indicated as of interest for purchasing) right now.

Thus, such embodiments can utilize data and analytics to identify an insurance client lead—e.g., the inquiring insurance buyer—for a subset of insurance agents best suited to close on that lead and, in addition, provide a warm connection to that insurance client lead to help increase the odds of a successful sale transaction. Disclosed embodiments can provide this useful advantage through a combination of unique data acquired from insurance agents (e.g., acquiring from each of a plurality of insurance agents an indication as to whether the respective insurance agent of the plurality of insurance agents is currently available for a phone call) and unique mechanism(s) to generate a warm lead and transfer that warm lead to a claiming insurance agent. This warm client lead can include, for instance, making the connection between a claiming insurance agent and the insurance client lead all while the insurance client lead is maintained on a phone line throughout the process of receiving the information identifying the insurance client lead to the point of connecting the claiming insurance agent and the insurance client lead. For example, this connection can include transferring an in-progress phone call with the insurance client lead to the insurance agent from whom a lead claim response was received while the insurance client lead was maintained on the phone call.

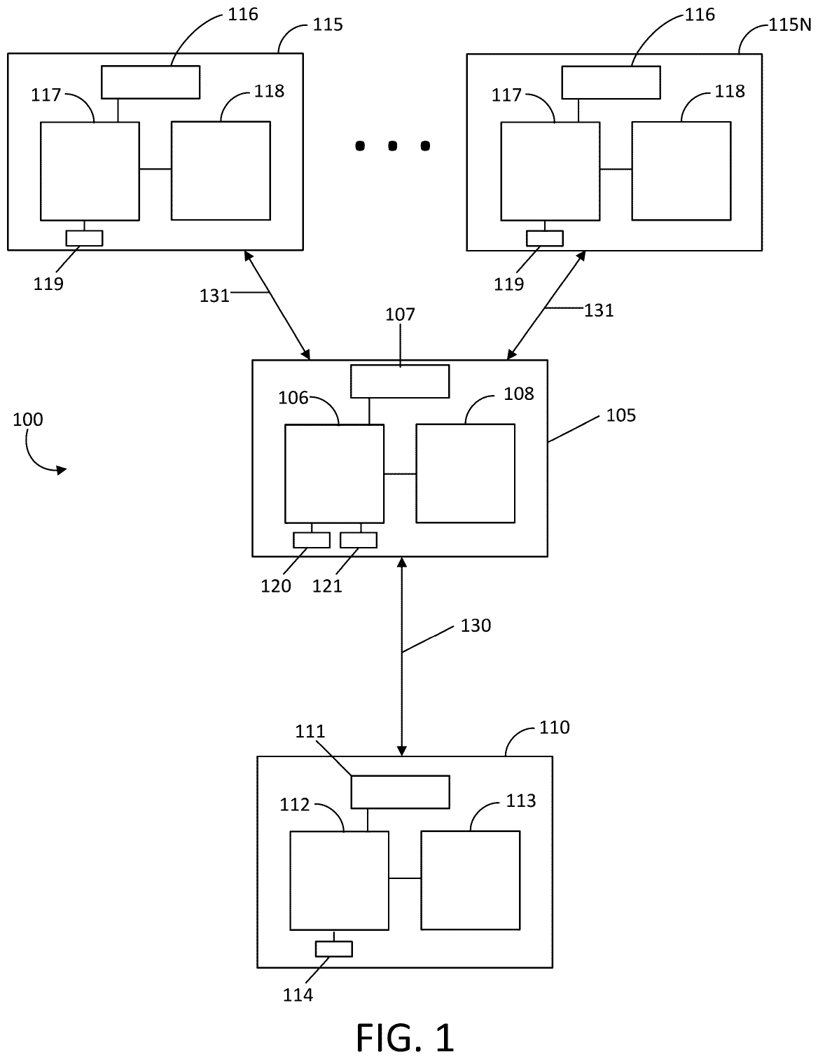

FIG. 1 is a schematic block diagram illustrating an embodiment of a system 100. As will be described further herein, the system 100 can be configured to utilize data and analytics to identify in substantially real-time a subset of one or more licensed professional insurance agent(s) that is: (i) best suited to help a specific inquiring insurance buyer with that inquiring buyer's specific, current insurance policy need(s), and (ii) currently available to engage with that inquiring insurance buyer and willing to provide the specified service to that insurance buyer right now.

The system 100 can include a central computing device 105. The central computing device 105 can be, for instance, a remote server that facilitates data collection and exchange as well as data analytics and/or user interface feature generation via execution of non-transitory computer-executable instructions thereat. The central computing device 105 can include programmable processing circuitry 106 and non-transitory storage medium 108 that is coupled to the programmable processing circuitry 106. Storage medium 108 can store non-transitory computer-executable instructions, and programmable processing circuitry 106 can be configured to execute the non-transitory computer-executable instructions stored at the storage medium 108, for instance, to carry out the functions described elsewhere herein. Central computing device 105 can additionally include a transceiver (e.g., wireless transceiver) 107 that is coupled to the programmable processing circuitry 106, and the transceiver 107 can be configured to receive and transmit data via one or more networks (e.g., using an IEEE 802.11 protocol to receive and transmit data via the Internet). The central computing device 105 can further include a user interface 120. The user interface 120 can be configured to receive one or more inputs from a user of the central computing device 105 and/or output data and indications to a user of the central computing device 105.

The central computing device 105 can further include a client lead module 121. The client lead module 121 can include a non-transitory storage component storing non-transitory computer-executable instructions and programmable processing circuitry. For instance, the storage component at the client lead module 121 can include a database of a plurality of insurance agents along with various data points stored in association with each such insurance agent in the database. For example, the database of the plurality of insurance agents can include stored information identifying which insurance agents in which geographic locations sell what particular types of insurance policies (e.g., auto insurance; commercial property insurance; residential property insurance; life insurance; etc.) and/or which insurance agents are available right now for a phone call (e.g., as a result of an input received from that insurance agent indicating he/she is available right now for a phone call). The programmable processing circuitry can be configured to execute the non-transitory computer-executable instructions to cause the client lead module 121 to use data at the central computing device 105, including data in the insurance agent database, to identify, from the database of a plurality of insurance agents, a subset of one or more insurance agents from the plurality of insurance agents based on information received from and identifying an insurance client lead. The client lead module 121 can include machine learning logic to provide a closed loop data analysis and leaning function such that the non-transitory computer-executable instructions at the client lead module 121 can change over time as a function of the data executed on by the client lead module 121.

The client lead module 121 can be executed at the central computing device 105 to carry out one or more aspects of the method 200 described elsewhere herein. For instance. The central computing device 105 can execute the client lead module 121 to cause the programmable processing circuitry 106 to receive information identifying an insurance client lead; use the received information identifying the insurance client lead to identify, from a database of a plurality of insurance agents, a subset of one or more insurance agents from the plurality of insurance agents; transmit a client lead notification to each of the subset of the one or more insurance agents from the plurality of insurance agents, the client lead notification corresponding to the insurance client lead; receive a lead claim response to the client lead notification from a first insurance agent of the subset of the one or more insurance agents, the lead claim response indicating a claim of the insurance client lead by the first insurance agent; and in response to receiving the lead claim response from the first insurance agent, connect the first insurance agent with the insurance client lead.

In addition to the central computing device 105, the system 100 can also include an insurance client lead device 110 and a plurality of insurance agent devices 115-115N. For instance, the insurance client lead device 110 and the plurality of insurance agent devices 115-115N can be programmable computing devices, such as a mobile computing device, like a laptop or mobile phone. The insurance client lead device 110 can be in data communication with the central computing device 105 via a communication link 130 (e.g., an IEEE 802.11 Internet protocol link; a cellualr link; etc.), and each of the plurality of insurance agent devices 115-115N can be in data communication with the central computing device 105 via a communication link 131 (e.g., an IEEE 802.11 Internet protocol link; a cellualr link; etc.). In this way, the central computing device 105 can sever as an intermediary between the insurance client lead device 110 and the plurality of insurance agent devices 115-115N thereby allowing the central computing device 105 to receive data, analyze received and/or previously stored data, and transmit data (e.g., notifications resulting from analysis of received and/or previously stored data) between the insurance client lead device 110 and the plurality of insurance agent devices 115-115N (e.g., a select subset of the plurality of insurance agent devices 115-115N).

The insurance client lead device 110 can include programmable processing circuitry 112 and non-transitory storage medium 113 that is coupled to the programmable processing circuitry 112. Storage medium 113 can store non-transitory computer-executable instructions, and programmable processing circuitry 112 can be configured to execute the non-transitory computer-executable instructions stored at the storage medium 113, for instance, to carry out the functions described elsewhere herein, including those described elsewhere herein with respect to functions and actions associated with an insurance client lead. Insurance client lead device 110 can additionally include a transceiver (e.g., wireless transceiver) 111 that is coupled to the programmable processing circuitry 112, and the transceiver 111 can be configured to receive and transmit data via one or more networks (e.g., using an IEEE 802.11 protocol to receive and transmit data via the Internet), for instance to receive data from, and transmit data to, the central computing device 105 via the communication link 130. The insurance client lead device 110 can further include a user interface 114 (e.g., display and associated computing peripherals such as buttons; touchscreen; etc.). The user interface 114 can be configured to receive one or more inputs from a user of the insurance client lead device 110 and/or output data and indications to a user of the insurance client lead device 110.

Each of the plurality of insurance agent devices 115-115N can include programmable processing circuitry 117 and non-transitory storage medium 118 that is coupled to the programmable processing circuitry 117. Storage medium 118 can store non-transitory computer-executable instructions, and programmable processing circuitry 117 can be configured to execute the non-transitory computer-executable instructions stored at the storage medium 118, for instance, to carry out the functions described elsewhere herein, including those described elsewhere herein with respect to functions and actions associated with an insurance agent. Each of the plurality of insurance agent devices 115-115N can additionally include a transceiver (e.g., wireless transceiver) 116 that is coupled to the programmable processing circuitry 117, and the transceiver 116 can be configured to receive and transmit data via one or more networks (e.g., using an IEEE 802.11 protocol to receive and transmit data via the Internet), for instance to receive data from, and transmit data to, the central computing device 105 via the communication link 131. Each of the plurality of insurance agent devices 115-115N can further include a user interface 119 (e.g., display and associated computing peripherals such as buttons; touchscreen; etc.). The user interface 119 can be configured to receive one or more inputs from a user of the respective insurance agent device 115-115N and/or output data and indications to a user of the respective insurance agent device 115-115N.

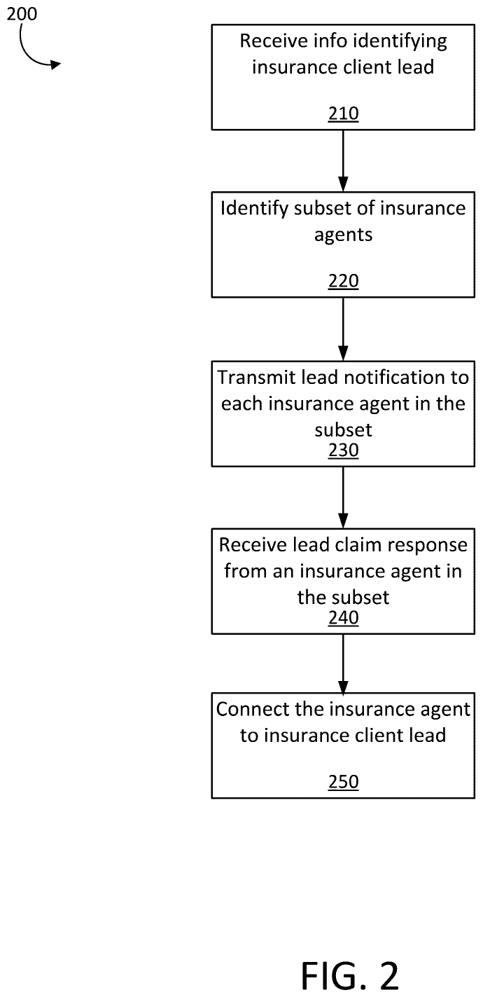

FIG. 2 illustrates a flow diagram of an embodiment of a method 200. The method 200 can be carried out in a variety of applications and environments, and one such example includes execution of the method 200 in a system such as that shown and described with respect to FIG. 1.

At step 210, the method 200 includes receiving information identifying an insurance client lead. Information identifying an insurance client lead can include information received from an insurance client lead who is inquiring about purchasing one or more insurance policies. Information identifying an insurance client lead can include personal identifying information regarding that insurance client lead, such as name, particular type(s) of insurance policy desired by the insurance client lead, insurance risk details (e.g., past claim history of the insurance client lead; value of asset(s) seeking to be insured; etc.), and/or a geographic location where the particular type(s) of insurance policy desired is to be applied. Information received from the insurance client lead can be received verbally via a telephone call with the insurance client lead and/or electronically via electronic data exchange. In some embodiments information identifying an insurance client lead can be received from more than one source, for instance from the insurance client lead himself/herself and a third party source (e.g., third party subscription database).

At step 220, the method 200 includes using the received information identifying the insurance client lead (e.g., received at step 210) to identify, from a database of a plurality of insurance agents, a subset of one or more insurance agents from the plurality of insurance agents in the database. This can include analyzing data associated with each such insurance agent in the database to screen out those agents in the database who are less compatible with what the insurance client lead is seeking, for instance, because those screened out agents do not offer the particular insurance policy desired at the specified geographic location. For example, in one embodiment, using the received information identifying the insurance client lead to identify the subset of one or more insurance agents from the plurality of insurance agents at step 220 can include using the type of insurance policy desired by the insurance client lead and the geographic location where the type of insurance policy desired by the insurance client lead is to be applied to identify the subset of one or more insurance agents from the plurality of insurance agents as those insurance agents offering the type of insurance policy desired by the insurance client lead at the geographic location where the type of insurance policy desired by the insurance client lead is to be applied.

In a further such example, at step 220, the method 200 can include using, in addition to the type of insurance policy desired by the insurance client lead and the geographic location where the type of insurance policy desired by the insurance client lead is to be applied, one or more additional types of data to identify, from a database of a plurality of insurance agents, the subset of one or more insurance agents from the plurality of insurance agents in the database. For example, in addition to using received information identifying the insurance client lead, step 220 can also use information identifying one or more aspects relating to each of the plurality of insurance agents stored in the database. Such information identifying one or more aspects relating to each of the plurality of insurance agents stored in the database can include, for instance, an insurance agent quality score (e.g., a composite metric created to correspond to past quality/satisfaction ratings of each insurance agent from previous insurance clients who worked with the insurance agent) and/or an insurance agent appetite match (e.g., a composite metric created to correspond to a predicted degree of interest that each insurance agent will have in the specific client lead at issue, for instance, using data such as the number of insurance client leads claimed by each insurance agent over a preset past period of time with the lesser number of claimed leads and the longer the past period of time leading to a relatively higher insurance agent appetite match). Thus, for example, at step 220, to identify the subset of one or more insurance agents from the plurality of insurance agents in the database, the method 200 can use, in addition to one or more data points relating to insurance client lead information, an insurance agent quality score and/or an insurance agent appetite match to identify insurance agents from the plurality in the database to identify for inclusion in the subset of insurance agents such that those insurance agents with relatively higher insurance agents quality scores and/or relatively higher insurance agent appetite match scores are identified for inclusion in the subset of insurance agents at step 220.

In a further embodiment of the method 200, to help with using the received information identifying the insurance client lead to identify, from a database of a plurality of insurance agents, a subset of one or more insurance agents from the plurality of insurance agents at step 220, the method 200 can further include receiving, from at least some (e.g., each) of the plurality of insurance agents in the database, an indication as to whether the respective insurance agent of the plurality of insurance agents is currently available for a phone call with the insurance client lead. Then, this indication as to whether the respective insurance agent in the database is currently available for a phone call with the insurance client lead can be used (e.g., along with specified policy type and geographic location) to screen out those insurance agents who are not currently available for such phone call. Namely, in this embodiment, at step 220, identifying the subset of one or more insurance agents from the plurality of insurance agents can include using the received information identifying the insurance client lead and the indication as to whether the respective insurance agent of the plurality of insurance agents is currently available for the phone call.

At step 230, the method 200 includes transmitting a client lead notification to each of the subset of the one or more insurance agents from the plurality of insurance agents (e.g., transmitting to each insurance agent device associated with each insurance agent in the subset). The client lead notification can correspond to the insurance client lead inquiring about a purchasing one or more particular types of insurance policies and for whom identifying information was received at step 210. The client lead notification can be transmitted to each of the subset of the one or more insurance agents from the plurality of insurance agents (e.g., only those insurance agents who passed the screening at step 220) along with an indicator indicating whether the insurance client lead is currently waiting on a phone line to talk with an insurance agent of the subset of the one or more insurance agents. In a further such example, the client lead notification can be transmitted to each of the subset of the one or more insurance agents from the plurality of insurance agents additionally along with a type of insurance policy desired by the insurance client lead and a calculated estimated agent premium fee associated with the type of insurance policy desired by the insurance client lead.

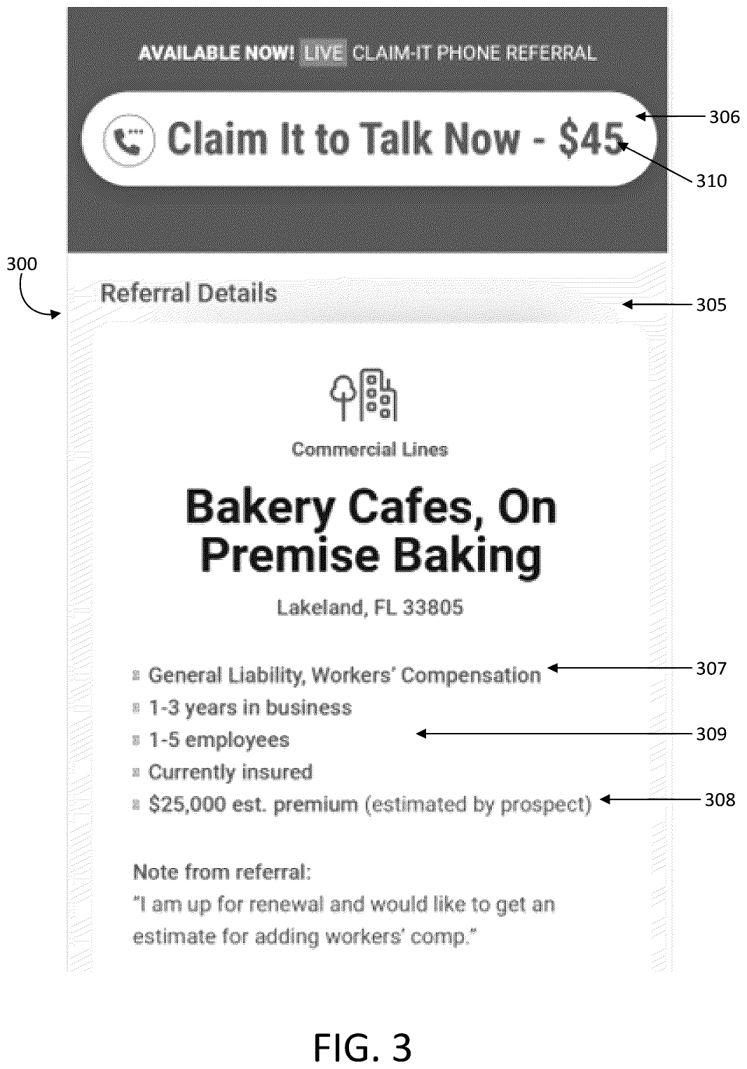

Referring to FIG. 3, FIG. 3 shows an embodiment of a user interface 300 that can be displayed at an insurance agent device. This displayed user interface 300 includes one example of a client lead notification 305. This illustrated embodiment of the client lead notification 305 includes: (i) an available client lead notification indicator 306 that can convey to the insurance agent viewing the user interface 300 the current existence of an inquiring insurance client lead seeking to purchase a desired insurance policy and the ability of that viewing insurance agent to claim that insurance client lead right now, (ii) a type of insurance policy indicator 307 indicating a particular type of insurance policy that the insurance client lead has identified as of interest to purchase, and (iii) a calculated estimated insurance agent premium fee 308 associated with the type of insurance policy desired by the insurance client lead. As also illustrated at this example at FIG. 3, the client lead notification 305 can further include bibliographic type information 309 providing data relating to background and context of the insurance client lead (e.g., insurance risk profile, such as years in business; current insurance status (e.g., whether currently insured for the policy being sought for purchase); and/or indication as to the size of the business or residence being insured (e.g., number of employees; historical financial information, such as historical revenue; an estimated market value of the asset to be insured; etc.)) that can be helpful to the insurance agent(s) viewing the user interface 300 in determining whether to claim the insurance client lead. As will be described further, the client lead notification 305 can provide an input ability for the insurance agent(s) viewing the client lead notification 305 at the user interface 300 for such insurance agent(s) to input his/her claim of that insurance client lead. In this illustrated example of FIG. 3, this can include an input provided at the available client lead notification indicator 306 as a means for the insurance agent to provide a lead claim response and, thereby, to claim the insurance client lead.

At step 240, the method 200 includes receiving a lead claim response to the client lead notification from a first insurance agent of the subset of the one or more insurance agents, the lead claim response indicating a claim of the insurance client lead by the first insurance agent. In one embodiment, the lead claim response received at step 240 can be received from only one insurance agent of the subset of the one or more insurance agents previously passing the screen at step 220 (e.g., from only the first insurance agent in time from which the lead claim response was received). As described in reference to FIG. 3, the lead claim response can be provided by the claiming insurance agent by providing an input at (e.g., clicking, touching, etc.) the available client lead notification indicator 306. An insurance agent providing such input at the available client lead notification indicator 306 can cause the associated insurance agent device to transmit a claim notification to the central computing device which in turn can cause the central computing device to award the insurance client lead to that claiming insurance agents and, thereby, prevent future claims of that same insurance client lead by any other insurance agent.

In various embodiments, the method 200 can additionally include one or more steps associated with setting a lead claim price. For instance, as shown at the exemplary client lead notification 305 of FIG. 3, a lead claim price 310 is included at the client lead notification 305. As such, the lead claim price 310 can be transmitted along with the client lead notification 305 to each of the subset of the one or more insurance agents from the plurality of insurance agents (e.g., those insurance agents passing the screen at step 220). The lead claim price 310 can be a price to be charged to an insurance agent who claim the insurance client lead. For example, the lead claim price can be charged to the claiming insurance agent as a result of the insurance agent providing a claim input at the available client lead notification indicator 306.

The lead claim price can be variable and set dynamically based on one or more of a variety of data points. For example, as to the one or more data points that can be used to set the lead claim price, the lead claim price can be determined using one or more (e.g., each) of a type of insurance policy desired by the insurance client lead, a location where the type of insurance policy desired by the insurance client lead is to be applied, a time of day when the client notification is transmitted, and a total number of insurance agents in the subset of one or more insurance agents identified from the database of the plurality of insurance agents. As another example, as to the variable and dynamic nature of setting the lead claim price, initially the lead claim price can be set to a first lead claim price and the first lead claim price can be transmitted, along with the client lead notification, to each of the subset of the one or more insurance agents from the plurality of insurance agents (e.g., transmitted to those agents passing the screen at step 220). Then, after transmitting the first lead claim price, that first lead claim price can be decreased to a second, lesser lead claim price in response to a predetermined amount of time passing, after transmitting the client lead notification to each of the subset of the one or more insurance agents, without yet having received the lead claim response. Thus, the initial, first lead claim price can be decreased incrementally (e.g., by a preset amount) as a result of each passing preset interval of time without the client lead notification having been claimed by an agent. This second, lesser lead claim price can be transmitted, along with the client lead notification, in place of the initial, first lead claim price to each of the subset of the one or more insurance agents from the plurality of insurance agents. Accordingly, this dynamic and variable ability to adjust the lead claim price can help to align the lead claim price with the conditions of the market for claiming it at the given time the client lead notification is sent to prospective claiming agents (e.g., time of the day, number of insurance agents passing the screen at step 220 and thus receiving the client lead notification, amount of the estimated insurance policy premium, etc.).

In some embodiments of the method 200, an additional step of transmitting the received information identifying the insurance client lead (e.g., received at step 210) to a claiming insurance agent can be included. For example, the method 200 can include, in response to receiving the lead claim response from the first insurance agent, transmitting to that first insurance agent the received information identifying the insurance client lead.

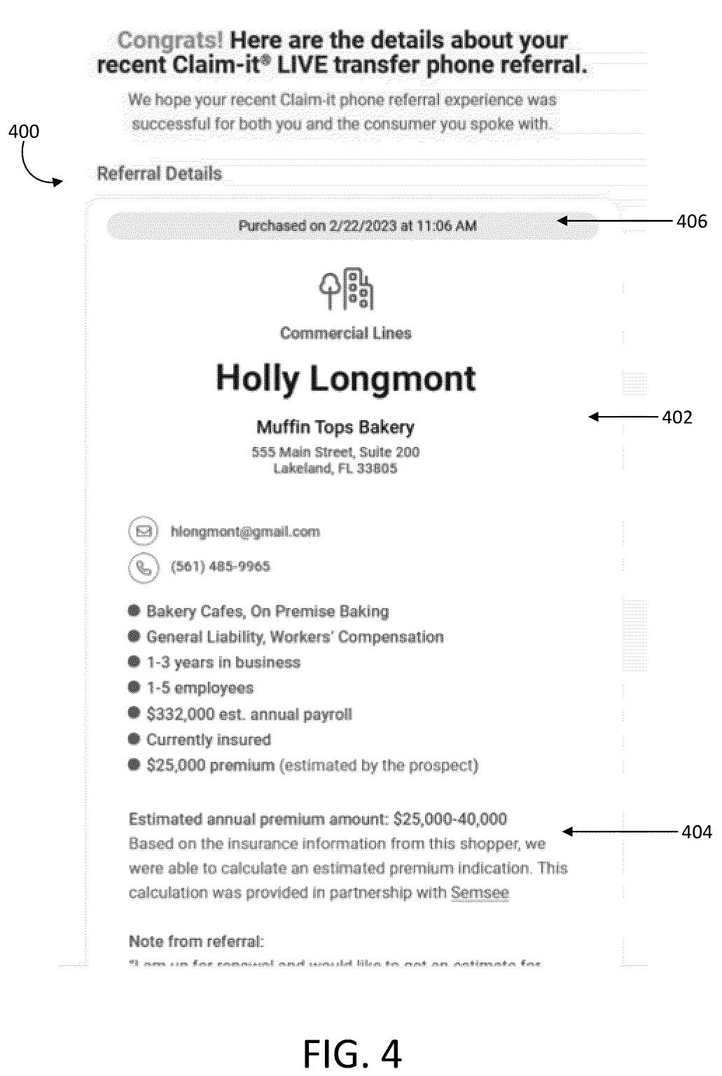

As one such example, FIG. 4 illustrates an embodiment a user interface 400 that includes one example of information identifying an insurance client lead 402 transmitted to a claiming insurance agent in response to that insurance agent having claimed the corresponding insurance client lead. Thus, as a result of the insurance agent having successfully claimed the insurance client lead (e.g., by providing input, such as clicking or touching, at the available client lead notification indicator 306), the insurance agent device corresponding to that claim winning insurance agent can receive, and display, the information identifying an insurance client lead 402. The information identifying an insurance client lead 402 can include a name of the insurance client lead client, a geographic location at which the insurance policy is to be applied, a particular type of insurance policy to be applied, bibliographic type information providing data relating to background and context of the insurance client lead (e.g., contact information (e.g., phone number and/or email address), size of business, number of employees, current insurance status, current annual insurance premium if applicable etc.), and/or an estimated annual premium amount 404 to be charged for the corresponding particular type of insurance policy being sold. As also shown at the example of FIG. 4, the user interface 400 can additionally include, in certain embodiments, a purchase confirmation indication 406. The purchase confirmation indication 406 can be provided with the information identifying an insurance client lead 402 and, thus, transmitted to a claiming insurance agent in response to that insurance agent having claimed the corresponding insurance client lead.

In some embodiments of the method 200, an additional step of transmitting a feedback prompt to the first insurance agent requesting from the first insurance agent information relating to a sale of an insurance policy to the insurance client lead. For example, the method 200 can include, in response to receiving the lead claim response from the first insurance agent, transmitting a feedback prompt to the first, claiming insurance agent requesting from the first insurance agent information relating to a sale of an insurance policy to the insurance client lead. The information relating to the sale of the insurance policy to the insurance client lead included in the feedback prompt transmitted to the first, claiming insurance agent can include a request for information from the first insurance agent as to any additional insurance policy sold to the insurance client lead beyond a type of insurance policy indicted as desired by the insurance client lead in the received information identifying the insurance client lead. Thus, use of the feedback prompt can allow the central computing device to gather information it may not have otherwise has an opportunity to receive previously, for instance, such as information received from the insurance client lead and/or the claiming insurance agent after receiving the lead claim response.

The data received from the claiming insurance agent via the feedback prompt can be saved at the central computing device and used in subsequent executions of the method 200. For instance, where the data received from the claiming insurance agent via the feedback prompt indicates that the claiming insurance agent sold an additional insurance policy to the insurance client lead beyond a type of insurance policy the insurance client lead had previously indicated a desire to purchase, that claiming insurance agent can be given additional weight in the logic used to screen out insurance agents in a subsequent iteration of the method 200 such that the claiming insurance agent has a greater preferential weight to receive client lead notifications in a subsequent execution of the method 200.

At step 250, the method 200 includes, in response to receiving the lead claim response from the first insurance agent, connecting the first insurance agent with the insurance client lead.

For example, connecting the first, claiming insurance agent with the insurance client lead can include transferring a phone call with the insurance client lead to the first insurance agent. In one such embodiment, the information received from and identifying the insurance client lead (e.g., at step 210) can be received via a phone call with the insurance client lead at a time prior to transferring the phone call with the insurance client lead to the first insurance agent. More specifically, in one such embodiment, both the client lead notification can be transmitted and the lead claim response can be received while the phone call with the insurance client lead is occurring and prior to transferring the phone call with the insurance client lead to the first insurance agent.

Thus, in some embodiments, the method 200 can be carried out all while the insurance client lead is on an ongoing phone call, with some portions of the method 200 executed while the insurance client lead is on the ongoing phone call with the provider of the method 200 and then transferring the phone call with the insurance client lead to the first, claiming insurance agent such that the other, subsequent portions of the method 200 are executed while the insurance client lead is on the ongoing phone call with the claiming, first insurance agent. This sequence can be useful in facilitating the sharing of a warm lead from the provider of the method 200 to the claiming, first insurance agent, which in many instances can increase the probability of accomplishing a successful sale of one or more insurance policies by the first, claiming insurance agent. Moreover, the ability to accomplish this warm lead transfer can make the disclosed method aspect of having previosuly solicited and received an indication as to whether the respective insurance agent is currently available for the phone call all the more useful as this indication of insurance agent availability for a phone call right now can facilitate the useful ability to share the warm insurance client lead.

In another additional or alternative example, at step 250, the method 200 can include connecting the first, claiming insurance agent with the insurance client lead can include transmitting digital information identifying the insurance client lead to the claiming insurance agent in response to that insurance agent having claimed the corresponding insurance client lead. Thus, as a result of the insurance agent having successfully claimed the insurance client lead (e.g., at step 240) (e.g., by providing input, such as clicking or touching, at the available client lead notification indicator), the insurance agent device corresponding to that claim winning insurance agent can receive, and display, the information identifying an insurance client lead.

For instance, as described previously, FIG. 4 illustrates one embodiment of such information identifying an insurance client lead. As FIG. 4 illustrates, such information identifying the insurance client lead can include a name of the insurance client lead client, a geographic location at which the insurance policy is to be applied, a particular type of insurance policy to be applied, bibliographic type information providing data relating to background and context of the insurance client lead (e.g., contact information (e.g., phone number and/or email address), size of business, number of employees, current insurance status, current annual insurance premium if applicable etc.), and/or an estimated annual premium amount to be charged for the corresponding particular type of insurance policy being sold. Connecting the first, claiming insurance agent with the insurance client lead at step 250 by, for instance, transmitting digital information identifying the insurance client lead to the claiming insurance agent in response to that insurance agent having claimed the corresponding insurance client lead can be useful, for example, in instances where the claiming insurance agent may be unavailable at the current time to take a phone call with the insurance client lead and, as such, the ability to transfer a phone call, with the insurance client lead, to the claiming insurance agent may not be available at the given time step 250 is executed to connect the claiming insurance agent to the insurance client lead.

In one embodiment, step 250 can include both transferring a phone call, with the insurance client lead, to the claiming insurance agent and transmitting digital information identifying the insurance client lead to the claiming insurance agent in response to that insurance agent having claimed the corresponding insurance client lead. For example, method 200 at step 250 could include determining whether the claiming insurance agent is currently available for a phone call with the insurance client lead. If so, step 250 can then include transferring a phone call, with the insurance client lead, to the claiming insurance agent in response to that insurance agent having claimed the corresponding insurance client lead and that insurance agent, who has claimed the corresponding insurance client lead, being determined as available currently for a phone call with the insurance client lead. If not, step 250 can then include transmitting digital information identifying the insurance client lead to the claiming insurance agent in response to that insurance agent having claimed the corresponding insurance client lead and that insurance agent, who has claimed the corresponding insurance client lead, being determined as not available currently for a phone call with the insurance client lead.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples of the disclosure have been described. Any combination of the described systems, operations, or functions is contemplated. These and other examples are within the scope of the following claims.

What is claimed is:

1. A method comprising the steps of:
receiving information identifying an insurance client lead;
using the received information identifying the insurance client lead to identify, from a database of a plurality of insurance agents, a subset of one or more insurance agents from the plurality of insurance agents;
transmitting a client lead notification to each of the subset of the one or more insurance agents from the plurality of insurance agents, the client lead notification corresponding to the insurance client lead;
receiving a lead claim response to the client lead notification from a first insurance agent of the subset of the one or more insurance agents, the lead claim response indicating a claim of the insurance client lead by the first insurance agent; and
in response to receiving the lead claim response from the first insurance agent, connecting the first insurance agent with the insurance client lead.

2. The method of claim 1, wherein connecting the first insurance agent with the insurance client lead comprises transferring a phone call with the insurance client lead to the first insurance agent.

3. The method of claim 2, wherein the information identifying the insurance client lead is received via the phone call with the insurance client lead and prior to transferring the phone call with the insurance client lead to the first insurance agent.

4. The method of claim 3, wherein both the client lead notification is transmitted and the lead claim response is received while the phone call with the insurance client lead is occurring and prior to transferring the phone call with the insurance client lead to the first insurance agent.

5. The method of claim 4, further comprising:
receiving, from each of the plurality of insurance agents in the database, an indication as to whether the respective insurance agent of the plurality of insurance agents is currently available for a phone call, and
wherein identifying the subset of one or more insurance agents from the plurality of insurance agents comprises using the received information identifying the insurance client lead and the indication as to whether the respective insurance agent of the plurality of insurance agents is currently available for the phone call.

6. The method of claim 2, wherein the lead claim response is received from only the first insurance agent of the subset of the one or more insurance agents.

7. The method of claim 1, wherein the received information identifying the insurance client lead includes a type of insurance policy desired by the insurance client lead and a location where the type of insurance policy desired by the insurance client lead is to be applied.

8. The method of claim 7, wherein using the received information identifying the insurance client lead to identify the subset of one or more insurance agents from the plurality of insurance agents includes using the type of insurance policy desired by the insurance client lead and the location where the type of insurance policy desired by the insurance client lead is to be applied to identify the subset of one or more insurance agents from the plurality of insurance agents as those insurance agents offering the type of insurance policy desired by the insurance client lead at the location where the type of insurance policy desired by the insurance client lead is to be applied.

9. The method of claim 1, further comprising:
setting a lead claim price to charge as a result of receiving the lead claim response to the client lead notification from the first insurance agent; and
transmitting the lead claim price, along with the client lead notification, to each of the subset of the one or more insurance agents from the plurality of insurance agents.

10. The method of claim 9, wherein the lead claim price is determined using each of a type of insurance policy desired by the insurance client lead, a location where the type of insurance policy desired by the insurance client lead is to be applied, a time of day when the client notification is transmitted, and a total number of insurance agents in the subset of one or more insurance agents identified from the database of the plurality of insurance agents.

11. The method of claim 10, wherein the lead claim price is set to a first lead claim price and the first lead claim price is transmitted, along with the client lead notification, to each of the subset of the one or more insurance agents from the plurality of insurance agents, and further comprising:
after transmitting the first lead claim price, decreasing the first lead claim price to a second, lesser lead claim price in response to a predetermined amount of time passing, after transmitting the client lead notification to each of the subset of the one or more insurance agents, without yet having received the lead claim response; and
transmitting the second, lesser lead claim price, along with the client lead notification, to each of the subset of the one or more insurance agents from the plurality of insurance agents.

12. The method of claim 1, wherein the client lead notification is transmitted to each of the subset of the one or more insurance agents from the plurality of insurance agents along with an indicator indicating whether the insurance client lead is currently waiting on a phone line to talk with an insurance agent of the subset of the one or more insurance agents.

13. The method of claim 12, wherein the client lead notification is transmitted to each of the subset of the one or more insurance agents from the plurality of insurance agents additionally along with a type of insurance policy desired by the insurance client lead and a calculated estimated agent premium fee associated with the type of insurance policy desired by the insurance client lead.

14. The method of claim 1, further comprising:
in response to receiving the lead claim response from the first insurance agent, transmitting to the first insurance agent the received information identifying the insurance client lead.

15. The method of claim 1, further comprising:
in response to receiving the lead claim response from the first insurance agent, transmitting a feedback prompt to the first insurance agent requesting from the first insurance agent information relating to a sale of an insurance policy to the insurance client lead.

16. The method of claim 15, wherein the information relating to the sale of the insurance policy to the insurance client lead included in the feedback prompt transmitted to the first insurance agent includes a request for information from the first insurance agent as to any additional insurance policy sold to the insurance client lead beyond a type of insurance policy indicted as desired by the insurance client lead in the received information identifying the insurance client lead.

17. A computing device comprising:
programmable processing circuitry;
a non-transitory storage medium coupled to the programmable processing circuitry; and
a transceiver coupled to the programmable processing circuitry and configured to receive and transmit data via a network,
wherein the programmable processing circuitry is configured to cause the device to:
receive information identifying an insurance client lead,
use the received information identifying the insurance client lead to identify, from a database of a plurality of insurance agents, a subset of one or more insurance agents from the plurality of insurance agents,
transmit a client lead notification to each of the subset of the one or more insurance agents from the plurality of insurance agents, the client lead notification corresponding to the insurance client lead,
receive a lead claim response to the client lead notification from a first insurance agent of the subset of the one or more insurance agents, the lead claim response indicating a claim of the insurance client lead by the first insurance agent, and
in response to receiving the lead claim response from the first insurance agent, connect the first insurance agent with the insurance client lead.

18. The device of claim 17, wherein the programmable processing circuitry is configured to cause the device to connect the first insurance agent with the insurance client lead by transferring a phone call with the insurance client lead to the first insurance agent, and wherein the programmable processing circuitry is configured to cause the device to both transmit the client lead notification and receive the lead claim response while the phone call with the insurance client lead is occurring and prior to transferring the phone call with the insurance client lead to the first insurance agent.

19. The device of claim 18, wherein the programmable processing circuitry is further configured to:
receive, from each of the plurality of insurance agents in the database, an indication as to whether the respective insurance agent of the plurality of insurance agents is currently available for a phone call, and
identify the subset of one or more insurance agents from the plurality of insurance agents by using the received information identifying the insurance client lead and the indication as to whether the respective insurance agent of the plurality of insurance agents is currently available for the phone call.

20. The device of claim 17, wherein the programmable processing circuitry is further configured to:
set a first lead claim price to charge as a result of receiving the lead claim response to the client lead notification from the first insurance agent,
transmit the first lead claim price, along with the client lead notification, to each of the subset of the one or more insurance agents from the plurality of insurance agents,
after transmitting the first lead claim price, decrease the first lead claim price to a second, lesser lead claim price in response to a predetermined amount of time passing, after transmitting the client lead notification to each of the subset of the one or more insurance agents, without yet having received the lead claim response, and
transmit the second, lesser lead claim price, along with the client lead notification, to each of the subset of the one or more insurance agents from the plurality of insurance agents.
